(19) United States
(12) Patent Application Publication
(10) Pub. No.: US 2010/0110944 A1
(43) Pub. Date: May 6, 2010

(54) COMMUNICATION TERMINAL APPARATUS, COMMUNICATION ADMINISTERING APPARATUS, COMMUNICATION METHOD, COMMUNICATION PROGRAM, AND RECORDING MEDIUM

(75) Inventor: Hiroaki Shibasaki, Chiba (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/526,653

(22) PCT Filed: Aug. 15, 2007
(86) PCT No.: PCT/JP2007/052687

§ 371 Date: Aug. 11, 2009

(51) Int. Cl. H04B 1/44

(52) U.S. Cl. 370/282

(57) ABSTRACT

A communication terminal apparatus transmits to a communication administrating apparatus, request information requesting issue of identification information and including time information related to the transmission of the information from a requesting unit. The communication administrating apparatus, upon receipt, by a receiving unit, of the request information requesting issue of identification information, generates identification information via a generating unit, and the identification information generated is issued from an issuing unit to the communication terminal apparatus. The communication terminal apparatus sets, via a setting unit and as temporary identification information for performing communication with other communication terminal apparatuses (110B, 110C), the identification information issued from the communication administrating apparatus (120) in response to the request information.

### TECHNICAL FIELD

The present invention relates to a communication terminal apparatus that, using identification information, performs bidirectional communication; a communication administering apparatus that administers communication between communication apparatuses; and a communication method, communication program, and recording medium associated with these apparatuses. However, application of the present invention is not limited to the communication terminal apparatus, the communication administering apparatus, the communication method, the communication program, and the recording medium.

### BACKGROUND ART

Conventionally, navigation apparatuses scroll the display of a map of the environs of a vehicle based on vehicular position according to the advancement of the vehicle, as well as search for a guide route to a destination, display the guide route on the map and guide the driver to the destination. Among such navigation apparatuses, a navigation apparatus supporting Vehicle Information and Communication System (VICS, registered trademark), receives information that is provided by VICS and concerns congestion, accidents, regulations, etc. and in real-time, displays the information on the map.

Through the use of VICS, a driver can avoid congested roads, roads closed to traffic, and roads on which an accident has occurred, thereby arriving at a destination in a short period of time. Beacons, including optical beacons and radio beacons, are provided on roads as communication administrating apparatuses to enable the navigation apparatus to utilize the VICS information. VICS information transmitted from these beacons can be received by the navigation apparatus (for example, refer to Patent Document 1 below).

The navigation apparatus not only receives the VICS information transmitted from the beacons, but can further transmit information concerning the vehicle, such as speed and position, to the beacon (up-link). The beacon, by receiving the information from the navigation apparatus, can acquire more detailed traffic information and further feedback this information to the navigation apparatus.

Patent Document 1: Japanese Laid-Open Patent Application Publication No. 2006-3292

### DISCLOSURE OF INVENTION

### Problem to be Solved by the Invention

However, to transmit VICS information from the beacon to the navigation apparatus as disclosed in Patent Document 1, identification information, such as an ID, is necessary to identify a navigation apparatus. Thus, conventional technology like that disclosed in Patent Document 1, for example, involves assigning a fixed ID to each navigation apparatus and transmitting VICS information based on the ID.

Use of the fixed ID enables behavior of the navigation apparatus to be completely captured and as a result, the behavior of the user is identified. Thus, a problem arises in that some users may regard the lack of anonymity and personal identification with repugnance.

Hence, a system is being developed that in place of a fixed ID, uses an ID (LID) that protects anonymity and does not identify the user of the navigation apparatus to perform communication. When LID is used, typically a communication terminal apparatus acquires from a given communication administrating apparatus, an ID randomly generated; and uses for communication, an ID unrelated to the communication terminal apparatus as and LID.

When a random ID (LID) is transmitted from the communication administrating apparatus to the communication terminal apparatus, the communication terminal apparatus must be designated as the recipient. Therefore, use of the LID between communication terminal apparatuses enables communication that protects anonymity; however, from the communication administrating apparatus, it can be known which LID has been sent to which communication terminal apparatus. Consequently, a problem arises in that, from the communication administrating apparatus, behavior of the communication terminal apparatus is identified.

### Means For Solving Problem

A communication terminal apparatus according to the invention of claim 1 performs bidirectional communication with a designated communication destination using identification information acquired from a communication administrating apparatus. The communication terminal apparatus includes a requesting unit that inserts into request information requesting issue of identification information, time information related to transmission of the request information and transmits the request information to the communication administrating apparatus; and a setting unit that sets, as temporary identification information for communication performed with another communication terminal apparatus, identification information issued from the communication administrating apparatus in response to the request information.

A communication administrating apparatus according to the invention of claim 5 administrates issue of identification information used in communication between communication terminal apparatuses. The communication administrating apparatus includes a receiving unit that receives from a communication terminal apparatus, request information requesting identification information and inclusive of time information; a generating unit that, upon receipt of the request information by the receiving unit, generates the identification information using the request information that includes the time information; and an issuing unit that issues to the communication terminal apparatus, the identification information generated by the generating unit.

A communication terminal method according to the invention of claim 10 is a communication method of performing bidirectional communication with a designated communication destination using identification information acquired from a communication administrating apparatus. The communication terminal method includes a requesting step of inserting into request information requesting issue of identification information, time information related to transmission of the request information and transmitting the request information to the communication administrating apparatus; and a setting step of setting, as temporary identification information for communication performed with another communication terminal apparatus, identification information issued from the communication administrating apparatus in response to the request information.

A communication method according to the invention of claim 11 is a communication method of administrating issue of identification information used in communication between communication terminal apparatuses. The communication administrating method includes a receiving step of receiving from a communication terminal apparatus, request information requesting identification information and inclusive of time information; a generating step of generating, upon receipt of the request information at the receiving step, the identification information using the request information that includes the time information; and an issuing step of issuing to the communication terminal apparatus, the identification information generated at the generating step.

A communication program according to the invention of claim 12 causes a computer to execute the communication method according to claim 10 or 11.

A computer-readable recording medium according to the invention of claim 13 stores therein the communication program according to claim 12.

### BRIEF DESCRIPTION OF DRAWINGS

FIG. 1 is a block diagram of a system configuration according to the present embodiment;

FIG. 2 is a flowchart of communication terminal apparatus processing;

FIG. 3 is a flowchart of communication administrating apparatus processing;

FIG. 4 is a diagram of system configuration in the example;

FIG. 5 is a block diagram of a hardware configuration of a navigation apparatus;

FIG. 6 is a hardware configuration of a server apparatus built-in a communication center;

FIG. 7 is a flowchart of processing for acquisition of anonymity-protecting ID of the navigation apparatus; and

FIG. 8 is a flowchart of processing for issuing an anonymity-protecting ID by the server apparatus.

### EXPLANATIONS OF LETTERS OR NUMERALS

110 communication terminal apparatus
111 requesting unit
112 setting unit
120 communication administrating unit
121 receiving unit
122 generating unit
123 issuing unit

### BEST MODE(S) FOR CARRYING OUT THE INVENTION

With reference to the accompanying drawings, preferred embodiments of a communication terminal apparatus, a communication administrating apparatus, a communication method, a communication program, and a recording medium according to the present invention will be explained.

### (System Configuration)

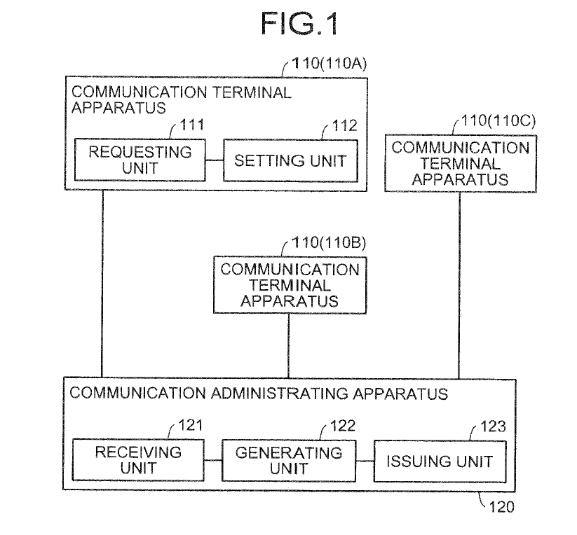

First, a system configuration according to the present invention will be explained. FIG. 1 is a block diagram of a system configuration according to the present embodiment. As depicted in FIG. 1, the present embodiment is made up of a system that includes communication terminal apparatuses 110 (110A, 110B, 110C) and a communication administrating apparatus 120.

One of the communication terminal apparatuses 110 (e.g., communication terminal apparatus 110A), establishes bidirectional communication with another one of the communication apparatuses 110 (e.g., communication terminal apparatus 110B) designated as a transmission destination. In performing the bidirectional communication, in order for the communication terminal apparatus 110B and/or 110C, which are transmission destinations of the communication terminal apparatus 110A, to designate the communication terminal apparatus 110A as a transmission origin, identification information is necessary. Further, by imparting a function of the communication terminal apparatus 110A to the communication administrating apparatus 120, the communication administrating apparatus 120 may be a transmission destination of the communication terminal apparatus 110A.

With the system configuration according to the present embodiment, the communication terminal apparatuses 110 acquire from the communication administrating apparatus communication administrating apparatus 120, identification information for performing bidirectional communication. Specifically, the communication terminal apparatuses 110 transmit to the communication administrating apparatus 120, request information requesting the issue of identification information. The communication administrating apparatus 120, upon the receipt of request information from a communication terminal apparatus 110, generates random identification information, i.e., identification information protecting anonymity, and issues the information generated to the communication terminal apparatus 110 that has transmitted the request information,

Here, bidirectional communication between the communication terminal apparatuses 110 and the communication administrating apparatus 120 involves the request and issue of identification information. However, conventionally, in the processing of the request and issue of identification information, since a communication terminal apparatus 110 is designated as the recipient of issued identification information with respect to the communication administrating apparatus 120, identification information unique to the apparatus is used in bidirectional communication with the communication administrating apparatus 120. That is, the communication terminal apparatus 110 reveals the real name thereof to the communication administrating apparatus 120 to perform communication.

According to the present embodiment, to protect the anonymity of the communication terminal apparatus 110, the communication terminal apparatus 110 uses identification information that protects anonymity even for bidirectional communication with the communication administrating apparatus 120, i.e., the communication terminal apparatus 110 uses the identification information that protects anonymity for all communication.

The communication terminal apparatuses 110, the communication administrating apparatus 120, including respective functions and processing thereof, for performing communication that involves the communication terminal apparatuses 110 and uses the identification information that protects anonymity will be explained.

### (Functional Configuration of Communication Terminal Apparatus)

A functional configuration of the communication terminal apparatuses 110 according to the present embodiment will be explained. As depicted in FIG. 1, each of the communication terminal apparatuses 110 is an apparatus that performs bidirectional communication with a designated transmission destination using identification information acquired from the communication administrating apparatus 120, and includes a requesting unit 111 and a setting unit 112.

The requesting unit 111 transmits to the communication administrating apparatus 120, request information requesting issue of identification information and inclusive of time information concerning the transmission of the request information. The request information is information requesting the communication administrating apparatus 120 to issue identification information. Specifically, to enable the communication administrating apparatus 120 to recognize the request information, the request information is of a predetermined format, includes a given flag, etc.

As explained, the request information includes time information. The time information is used to distinguish, for example, the communication terminal apparatus 110A from the communication terminal apparatuses 110B, 110C when the communication administrating apparatus 120 issues identification information to the communication terminal apparatus 110A, which has sent the request information. That is, the request information inclusive of time information is the identification information that is used in the bidirectional communication between the communication terminal apparatus 110A and the communication administrating apparatus 120 and further protects anonymity.

In this example, the time information is used as information to distinguish the communication terminal apparatus 110A from the communication terminal apparatuses 110B, 110C. However, other information such as a character string randomly generated by the communication terminal apparatus 110A may be included alternatively in the request information.

Further, the timing of the transmission of the request information by the request unit 111 may be arbitrarily set. For example, upon the instruction for commencement of bidirectional communication with the communication terminal apparatuses 110B and 110C by the user of the communication terminal apparatus 110A, request information requesting identification information that is to be newly used is transmitted. Further, once request information is transmitted and the identification information is received, upon the occurrence of a predetermined event, request information may be transmitted. That is, by automatically switching the identification information, identification of the behavior of the communication terminal apparatus 110A using the identification information can be prevented.

The setting unit 112 sets identification information issued from the communication administrating apparatus 120 in response to request information, as temporary identification information to be used in bidirectional communication with the communication terminal apparatuses 110B, 110C. As explained above, when the setting unit 112 receives identification information issued from the communication administrating apparatus 120, identification information newly generated (identification information protecting anonymity) is transmitted from the communication administrating apparatus 120. At this time, in the communication with the communication terminal apparatus 110A, the communication administrating apparatus 120 uses, as the information protecting anonymity, the time information (or other information) included in the request information transmitted by the communication terminal apparatus 110A. Therefore, the setting unit 112 sets the time information (or other information) as the identification information protecting the anonymity of the communication terminal apparatus 110A. Further, by temporarily setting the identification information protecting anonymity, identification of the behavior of the communication terminal apparatus 110A that sets identification information protecting anonymity and continuously uses the same identification information to use specific identification information, can be prevented.

Further, in the setting of the identification information protecting anonymity, a method may be used where the communication terminal apparatus 110 transmits proposed identification information to the communication administrating apparatus 120 and receives from the communication administrating apparatus 120, authorization to use the proposed identification information as the identification information. In such a method, the requesting unit 111 transmits to the communication administrating apparatus 120, request information and a request for authorization of a part of the request information or all of the request information (i.e., identification information). When the setting unit 112 receives a reply from the communication administrating apparatus 120 in response to the request for authorization to use all or a part of the request information as the identification information, the identification information is set as temporary identification information to be used in the communication with another communication terminal apparatus 110.

### (Functional Configuration of Communication Administrating Apparatus)

A functional configuration of the communication administrating apparatus according to the present embodiment will be explained. The communication administrating apparatus 120 is an apparatus that manages issue of identification information used in the communication between the communication terminal apparatuses 110, and as depicted in FIG. 1, includes a receiving unit 121, a generating unit 122, and an issuing unit 123.

The receiving unit 121 receives from the communication terminal apparatuses 110, request information requesting issue of identification information. The request information, for example, is information requesting the issue of identification information to the communication terminal apparatus 110A, which has sent the request information. To enable the receiving unit 121 to recognize the request information, the request information is of a predetermined format or includes a given flag. The request information includes time information or other information in lieu of the time information (e.g., a random character string). The time information (or other information) functions as identification information protecting anonymity and is for transmitting generated identification information to the communication terminal apparatus 110A.

The generating unit 122, upon receipt of request information by the receiving unit 121, uses the time information included in the request information received and generates identification information. If other information is used in lieu of time information, the information used in lieu of the time information is used to generate the identification information.

The issuing unit 123 issues to the communication terminal apparatus 110A, the identification information generated by the generating unit 122, i.e., performs processing to transmit the identification information generated to the communication terminal apparatus 110A that has sent the request information. To designate the communication terminal apparatus 110A as the transmission destination when the identification information is transmitted, the time information, or other information, included in the request information is used as the identification information protecting anonymity.

If the identification information generated by the generating unit 122 is identification information that has been generated already and is currently being used as the identification information of another communication terminal apparatus 110 (e.g., communication terminal apparatus 110B), i.e., if the identification information generated on this occasion is already being administered by the communication administrating apparatus 120, the issuing unit 123 transmits to the communication terminal apparatus 110A, an instruction to retransmit the request information.

As explained in paragraph 0031, when a method of transmitting proposed identification information from the communication terminal apparatus 110A to the communication administrating apparatus communication administrating apparatus 120 and of receiving authorization to use the proposed identification information as identification information is performed, processing different from that above is necessary for the communication administrating apparatus 120 as well. Specifically, when request information and a request for authorization to use all or a part of the request information as identification information are received by the receiving unit 121, if neither all nor a part of the request information is under administration as identification information, the generating unit 122 generates and returns a reply authorizing use of all or a part of the request information to the communication terminal apparatus 110A. Such processing enables proposed identification information transmitted from the communication terminal apparatus 110A to be utilized as actual identification information.

### (Communication Terminal Apparatus Processing)

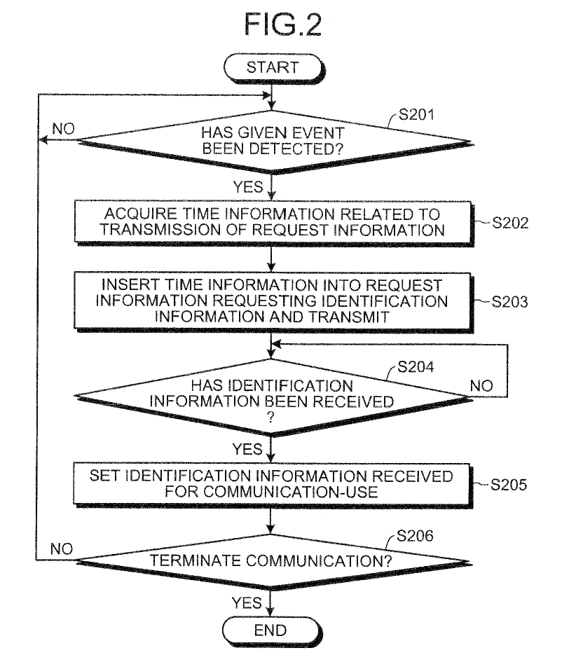

Processing performed by the communication terminal apparatuses 110 according to the present embodiment will be explained. FIG. 2 is a flowchart of communication terminal apparatus processing. Here, as one example, processing to acquire identification information used by the communication terminal apparatus 110A to communication with the communication terminal apparatuses 110B, 110C will be explained. Processing to acquire identification information by the communication terminal apparatus 110B, 110C is identical.

As depicted in the flowchart of FIG. 2, it is determined whether a given event has occurred with respect to the communication terminal, apparatus 110A (step S201). The given event is an event requiring acquisition of identification information, such as a new setting of the identification information, a required change, etc. Specifically, for example, the event may be start-up of the communication terminal apparatus 110A, the elapse of a given period from the acquisition of identification information from the communication administrating apparatus 120, may be appropriately set by the user, etc.

At step S201, detection of the given event is waited for (step S201: NO). When the given event occurs (step S201: YES), the requesting unit 111 acquires time information concerning the transmission of the request information (step S202). Further to acquire the identification information, the requesting unit 111 inserts the time information acquired at step S202 into the request information and transmits the request information to the communication administrating apparatus 120 (step S203).

The time information acquired at step S202 is inserted into the request information (step S203); however, this is only one example. If the information does not identify the communication terminal apparatus 110A as the communication terminal apparatus 110 that has transmitted the request information, other information may be used. For example, a character string randomly generated by the communication terminal apparatus 110A may be used. In such a case, at step S203, the generated character string is inserted into the request information and the request information is transmitted to the communication administrating apparatus 120.

Request processing at the communication terminal apparatus 110A to acquire identification information from the communication administrating apparatus 120 ends at step S203 and thereafter, flow proceeds to processing to acquire identification information from the communication administrating apparatus 120 and to use the identification information acquired in bidirectional communication with the communication terminal apparatuses 110B, 110C.

At the communication terminal apparatus 110A that has completed the processing at step S203, it is determined whether identification information issued from the communication administrating apparatus 120 has been received (step S204). Here, receipt of the identification information is waited for (step S204: NO). Upon receipt of the identification information (step S204: YES), the setting unit 112 sets the identification information received as communication-use identification information (step S205).

Finally, at the communication terminal apparatus 110A it is determined whether communication is to be ended (step S206). At step S206, if communication is to be continued (step S206: NO), flow returns to the processing at step S202, communication continues and if a predetermined event, the switching of identification information, occurs, flow proceeds to processing for acquiring the new identification information. On the other hand, if communication is to be terminated (step S206: YES), a series of the processing ends.

### (Processing by Communication Administrating Apparatus)

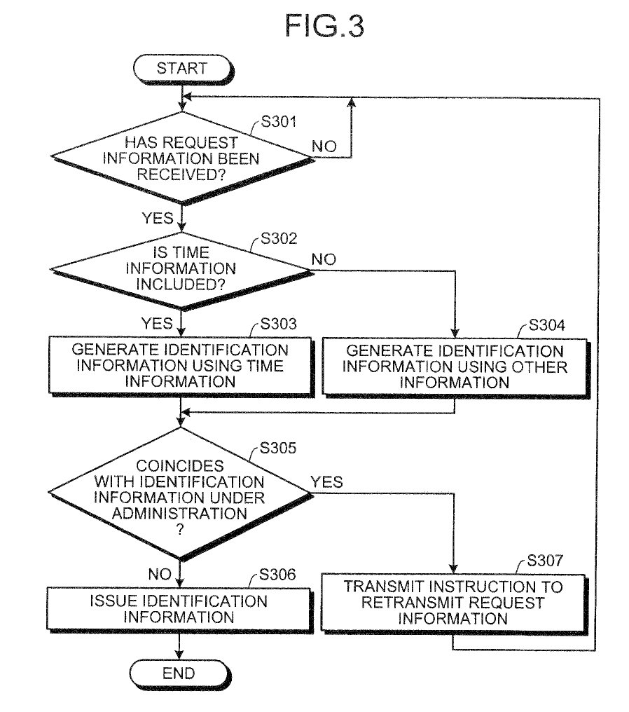

Next, processing performed by the communication administrating apparatus 120 according to the present embodiment will be explained. FIG. 3 is a flowchart of communication administrating apparatus processing. The communication administrating apparatus 120 generates identification information in response to a request for the issue of identification information from a communication terminal apparatus communication terminal apparatus communication terminal apparatus 110 and transmits the identification information generated to the communication terminal apparatus 110 that has transmitted the request.

As depicted in the flowchart of FIG. 3, the communication administrating apparatus 120 determines whether request information requesting issue of identification information has been received from the communication terminal apparatus 110A (step S301). Here, request information is determined to have been received when, for example, a predetermined condition is met such as a predetermined format indicative of request information and a flag indicating request information.

At step S301, receipt of request information is waited for (step S301: NO). Upon receipt of request information (step S301: YES), it is determined whether the request information received includes time information (step S302). If the request information includes time information (step S302: YES), the time information is used as identification information when transmitting generated identification information to the communication terminal apparatus 110A that has transmitted the request information. Accordingly, using the time information confirmed at step S302, the communication administrating apparatus 120 generates the identification information (step S303).

At step S302, if the request information does not include time information (step S302: NO), other information is included as the identification information to be used for transmissions back to the communication terminal apparatus 110A (e.g., a random character string generated by the communication terminal apparatus 110A); hence, this information is used to generate the identification information (step S304).

Upon generation of the identification information for communication terminal apparatus 110A at step S303 or S304, it is determined whether the generated identification information is information has been generated previously according to request information from another communication terminal apparatus 110 (e.g., communication terminal apparatus 110B, 110C) and is currently being used in bidirectional communication, i.e., whether the generated identification information coincides with identification information under administration of the communication administrating apparatus 120 (step S305).

At step S305, if the generated identification information coincides with identification information under administration of the communication administrating apparatus 120 (step S305: YES), the generated identification information cannot be used; hence, the communication administrating apparatus 120 transmits to the communication terminal apparatus 110A, an instruction to retransmit the request information (step S307), flow returns to step S301, and processing remains in standby until new request information is received.

At step S305, if the generated identification information and identification information under administration do not coincide (step S305: NO), the communication administrating apparatus 120 issues the generated identification information to the communication terminal apparatus 110A (step S306), and a series of the processing ends.

As explained, according to the present embodiment, a communication terminal apparatus 110 uses identification information issued by the communication administrating apparatus 120 to perform anonymous bidirectional communication with other communication terminal apparatuses 110. Further, upon receipt of identification information issued from the communication administrating apparatus 120, communication that utilizes time information, a random character string, etc. as identification information protecting anonymity is performed. Therefore, the communication terminal apparatuses 110 can perform communication that maintains anonymity.

### Example

An example of the present invention will be explained. In the example, the communication terminal apparatus 110 according to the present embodiment is applied as one function of a navigation apparatus. Further, the communication administrating apparatus 120 is implemented by a built-in server apparatus at a communication center that relays communication between the navigation apparatus and other communication terminal apparatuses.

### (System Configuration)

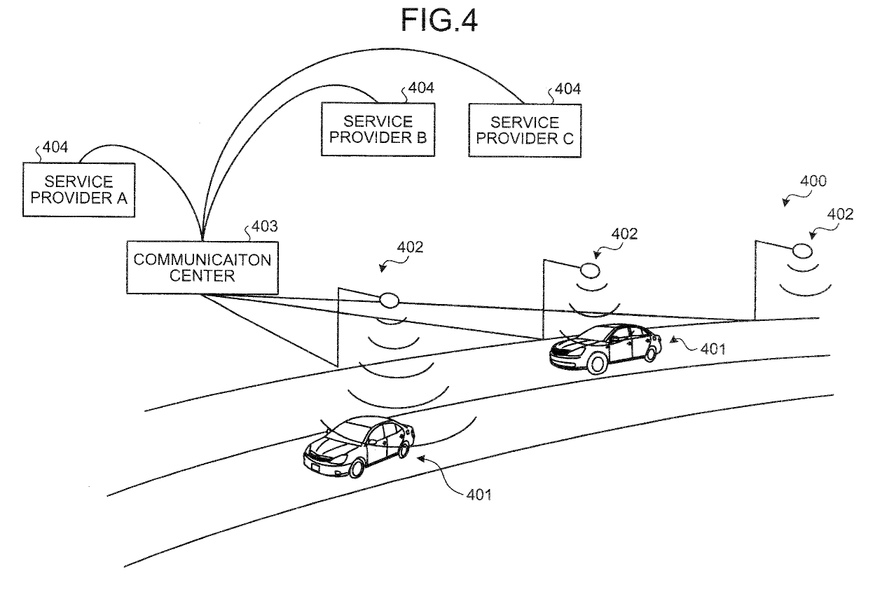

System configuration of the example will be explained. FIG. 4 is a diagram of the system configuration in the example. As depicted in FIG. 4, in a communication system 400 of a communication center 403 receives, by way of a beacon 402, a communication request transmitted from a vehicle 401, and by way of the communication center 403 establishes communication with a designated navigation apparatus equipped on another vehicle 401, a service provider 404 (service providers A to C), etc.

When a vehicle 401 communicates with another navigation apparatus, service provider 404, etc., the navigation apparatus equipped on the vehicle 401 acquires from the communication center 403, an anonymity-protecting ID that does not identify the navigation apparatus. The navigation apparatus implements bidirectional communication using the anonymity-protecting ID acquired.

### (Hardware Configuration of Navigation Apparatus)

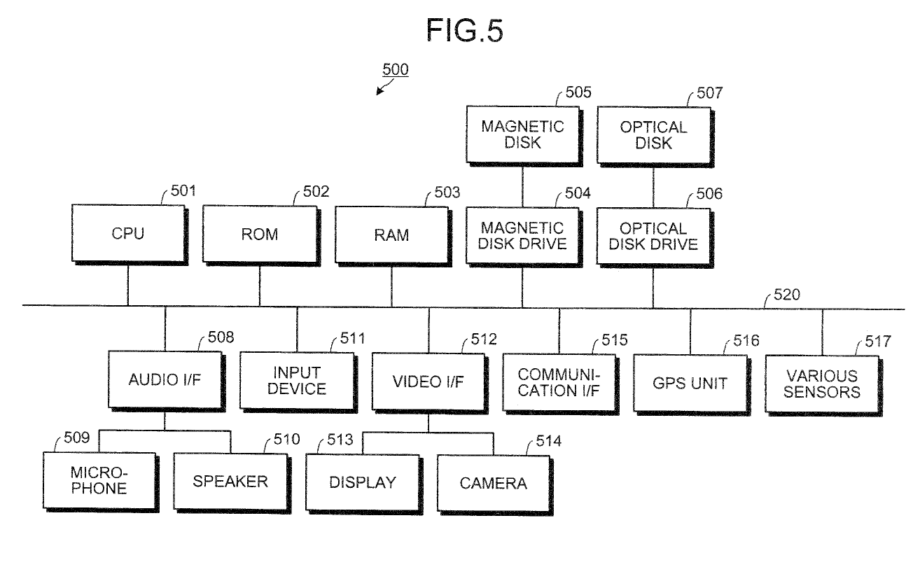

Hardware configuration of the navigation apparatus will be explained. FIG. 5 is a block diagram of a hardware configuration of the navigation apparatus. A navigation apparatus 500 is equipped on the vehicle 401.

As depicted in FIG. 5, the navigation apparatus 500 includes a CPU 501, a ROM 502, a RAM (memory) 503, a magnetic disk drive 504, a magnetic disk 505, an optical disk drive 506, an optical disk 507, an audio I/F (interface) 508, a microphone 509, a speaker 510, an input device 511, a video I/F 512, a display 513, a camera 514, a communication I/F (interface) 515, a CPS unit 516, and various sensors 517, all components respectively connected through a bus 520.

The CPU 501 governs overall control of the navigation apparatus 500. The ROM 502 stores therein various programs such as a boot program, navigation program, a communication program, etc. The RAM 503 is used a work area of the CPU 501.

The magnetic disk drive 504 controls the reading and the writing of data with respect to the magnetic disk 505 under the control of the CPU 501. The magnetic disk 505 records data written thereto under the control of the magnetic disk drive 504. As the magnetic disk 505, for example, an HD (hard disk), FD (flexible disk), etc. may be used.

The optical disk drive 506 controls the reading and the writing of the data with respect to the optical disk 507 under the control of the CPU 501. The optical disk 507 is a removable recording medium from which data is read under the control of the optical disk drive 506. The optical disk 507 may be a writable recording medium. As the removal recording medium, a medium other than the optical disk 507 can be employed, such as an MO and a memory card.

The audio I/F 508 is connected with the microphone 509 for audio input and the speaker 510 for audio output. Sound received by the microphone 509 is subjected to A/D conversion at the audio I/F 508. The speaker 510 outputs audio. Sound input from the microphone 509 may be recorded as audio data on the magnetic disk 505 or the optical disk 507.

The input device 511 may be, for example, a remote controller having keys used to input characters, numerical values, or various kinds of instructions, a keyboard, a mouse, or a touch panel. Further, the input device 511 may be connected to other information processing terminals, such a digital camera and a mobile phone terminal, to input and output data.

The video I/F 512 is connected to the display 513 for video output and the camera 514 for video input. The video I/F 512 is made up of, for example, a graphic controller that controls the display 513, a buffer memory such as VRAM (Video RAM) that temporarily stores immediately displayable image information, and a control IC that controls the display 513 based on image data output from the graphic controller.

The display 513 displays icons, cursors, menus, windows, or various data such as text and images. A CRT, a TFT liquid crystal display, a plasma display and so on can be employed as the display 513. The camera 514 captures images inside and outside the vehicle and outputs the images as data. Images captured by the camera 514 may be recorded on the magnetic disk 505 or the optical disk 507 as image data.

The communication I/F 515 performs wireless communication with the beacon 402 (refer to FIG. 4) and through the beacon 402 transmits information to the communication center 403. Further, the communication I/F 515 is further connected to various communication networks to transmit and receive information.

The network includes a LAN, a WAN, a public line network, a mobile telephone network and so on. Specifically, the communication I/F 515 is made up of, for example, an FM tuner, a VICS/beacon receiver, a radio navigation apparatus, and other navigation apparatuses, and acquires road traffic information concerning congestion and traffic regulations distributed from the beacon 402. As the road traffic information, for example, VICS information is received. The VICS information is road traffic information provided by Vehicle Information Center System (VICS) and concerns traffic congestion, accidents, regulations, etc. The VICS information acquired is displayed by the navigation apparatus in real-time. VICS is a registered trademark.

The GPS unit 516 receives signals from GPS satellites and outputs information concerning the position of the vehicle 401 (refer to FIG. 4) in which the navigation apparatus 500 is equipped. The information output by the GPS unit 516 is used together with values output from various sensors, described hereinafter, in the calculation of the current position of the vehicle 401, by the CPU 501. Information indicative of current position includes, for example, information indicating one point on map data, such as latitude, longitude, altitude, etc.

The various sensors 517 include a vehicular speed sensor and an angular speed sensor that respectively output information used to determine the position and behavior of the vehicle. Values output from the various sensors 517 are used by the CPU 501 to compute the current position and measure changes in speed, direction, etc.

In making a correlation with the hardware configuration of the navigation apparatus 500, the requesting unit 111 of the communication terminal apparatus 110 depicted in FIG. 1 is implemented by, for example, the CPU 501, the ROM 502, the RAM 503, and the input device 511. The setting unit is implemented by, for example, the CPU 501, the ROM 502, and the RAM 503.

### (Hardware Configuration of Server Apparatus)

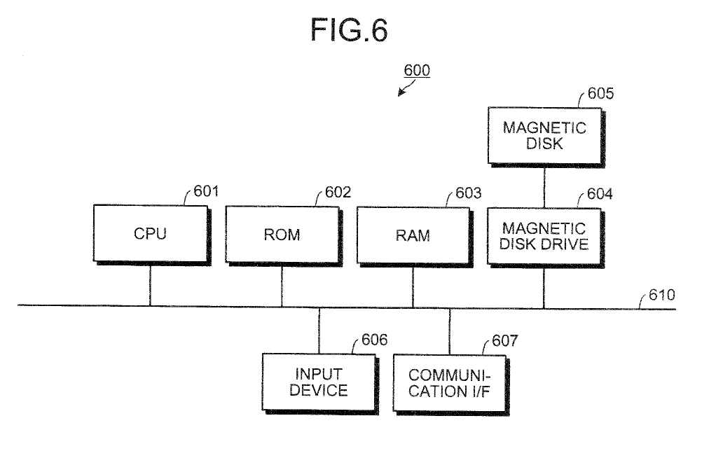

A hardware configuration of a server apparatus built-in the communication center 403. FIG. 6 is a hardware configuration of a server apparatus built-in the communication center. As depicted in FIG. 6, a server apparatus 600 includes a CPU 601, a ROM 602, a RAM 603, a magnetic disk drive 604, a magnetic disk 605, an input device 606, and a communication I/F (interface), respectively connected through a bus 610.

The CPU 601 governs overall control of the server apparatus 600. The ROM 602 stores therein various programs such as, route retrieving program, a guidance program, a communication program, etc. in addition to a boot program.

The RAM 603 is used a work area of the CPU 601. The magnetic disk drive 604 controls the reading and the writing of data with respect to the magnetic disk 605 under the control of the CPU 601. The magnetic disk 605 records data written thereto under the control of the magnetic disk drive 604.

The input device 606 has keys used to input characters, numerical values, or various kinds of instructions and is equipped with an external connector enabling connection of an independent keyboard. Since the input device 606 is provided for an apparatus intended for use as the server apparatus 600 built into a communication center that administers communication, the input device 606 may be a device that can be used by only designated personnel.

The communication I/F (interface) 607 is wirelessly connected to a communication network and functions to interface the CPU 601 with the navigation apparatus 500, other communication terminal apparatuses, the service providers 404, etc. Communication between the navigation apparatus 500 and other communication terminal apparatuses, the service providers 404 through the communication I/F may be performed directly, through a base station, etc. The communication I/F 607 is wirelessly connected to communication networks such as the Internet and functions as an interface between the CPU 601 and the communication networks.

With respect to the server apparatus 600, the receiving unit 121 and the issuing unit 123 of the communication administrating apparatus 120 depicted in FIG. 1, are implemented by, for example, the CPU 601, the ROM, 602, the RAM 603, and the communication I/F 607. The generating unit 122 is implemented by, for example, the CPU 601, the ROM 602, and the RAM 603.

### (Processing for Acquisition of Anonymity-Protecting ID of Navigation Apparatus)

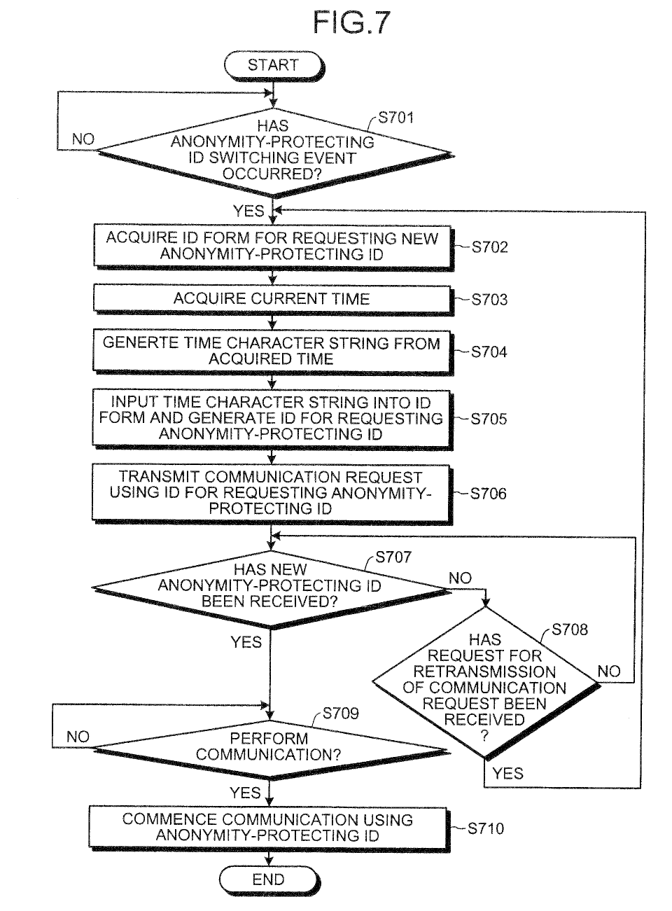

Processing, executed in the system according to the present example, to acquire the anonymity-protecting ID used when the navigation apparatus 500 communicates with a specific service provider will be explained. FIG. 7 is a flowchart of processing for acquisition of anonymity-protecting ID of the navigation apparatus. When the navigation apparatus 500 does not wish the behavior thereof to be identified, the navigation apparatus 500 uses the anonymity-protecting ID described above. The anonymity-protecting ID, unlike the usual ID, is a randomly generated character string. Therefore, by only referencing the anonymity-protecting ID formed by a character string, it is not known to which navigation apparatus 500 the anonymity-protecting ID is associated.

As depicted in the flowchart of FIG. 7, the navigation apparatus 500 determines whether an anonymity-protecting ID switching event has occurred (step S701). Here, an anonymity-protecting ID switching event is, for example, ignition of the engine of the vehicle 401, which does not have an anonymity-protecting ID stored, or is an event such as the lapse of a given period of time, the vehicle 401 traveling a given distance, etc. and can be appropriately set by the user of the navigation apparatus 500.

At step S701, the navigation apparatus 500 waits until the anonymity-protecting ID switching event has occurred (step S701: NO). Upon occurrence of the event (step S701: YES), the navigation apparatus 500 acquires an ID form for requesting a new anonymity-protecting ID (step S702) and further acquires the current time to be used in the ID form (step S703).

From the time acquired at step S703, the navigation apparatus 500 generates a time character string to be stored in the ID form (step S704). The navigation apparatus 500 inserts the time character string generated at step S704 into the ID form acquired at step S702, and generates an ID for requesting an anonymity-protecting ID (step S705).

The ID generated at step S705 and for requesting an anonymity-protecting ID may be an anonymity-protecting ID proposed for this occasion. In such a case, the ID generated for requesting an anonymity-protecting ID and a request for authorization to use the ID as an anonymity-protecting ID are transmitted to the server apparatus 600. Upon receipt of a response from the server apparatus 600 indicating authorization, the navigation apparatus 500 sets the ID for requesting an anonymity-protecting ID as the anonymity-protecting ID.

The ID generated at step S705 and for requesting an anonymity-protecting ID is used to transmit a communication request to the server apparatus 600 of the communication center 403 (step S706). Upon completion of the processing at step S706, the navigation apparatus 500 determines whether a new anonymity-protecting ID has been received from the server apparatus 600 of the communication center 403 in response to the communication request transmitted at step S706 (step S707).

As explained above, when the ID generated at step S705 and for requesting an anonymity-protecting ID is proposed as the anonymity-protecting ID for this occasion, the navigation apparatus 500 may determine whether a reply has been received authorizing the ID proposed as the anonymity-protecting ID and transmitted to the server apparatus 600.

At step S707, if a new anonymity-protecting ID is not received (step S707: NO), the navigation apparatus 500 determines whether a request for retransmission of the communication request has been received from the server apparatus 600 (step S708). If a request for retransmission of the communication request has been received (step S708: YES), flow returns to the processing at step S702 and the processing for transmitting a communication request using the ID for requesting an anonymity-protecting ID is repeated (steps S702 to S706). If the ID generated at step S705 and for requesting an anonymity-protecting ID is proposed as the anonymity-protecting ID for this occasion and no reply from the server apparatus authorizing identification information has been received, “NO” is determined at step S707.

On the other hand, at step S708, if a request for retransmission of the communication request has not been received (step S708: NO), flow returns to the processing at step S707 and the navigation apparatus 500 determines again whether a new anonymity-protecting ID has been received. Thus, the navigation apparatus 500 is in a standby state until a state in which either a new anonymity-protecting ID is received or a request for retransmission of the communication request is received.

At step S707, upon receipt of a new anonymity-protecting ID, the navigation apparatus 500 determines whether communication is to be performed (step S709). At step S709, determination whether to perform communication is based on an instruction from the user of the navigation apparatus 500 to commence communication, an instruction from a higher level program to commence communication, etc.

At step S709, waiting occurs until it is determined that communication is to commence (step S709: NO). Upon determination that communication is to commence (step S709: YES), the navigation apparatus 500 begins communication using the anonymity-protecting ID received at step S707 (step S710), and a series of processing to acquire an anonymity-protecting ID ends.

### (Processing for Issuing an Anonymity-Protecting ID by the Server Apparatus)

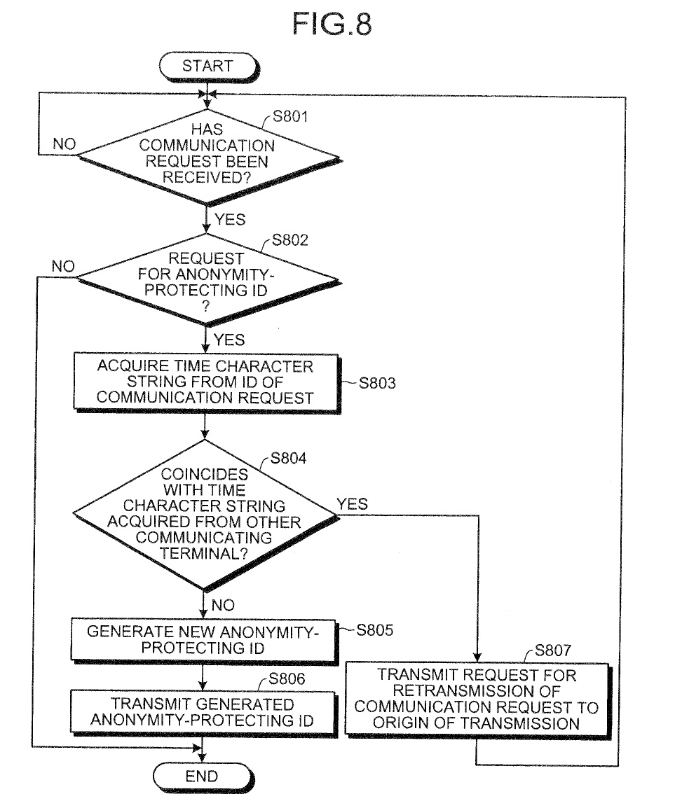

Processing for issuing an anonymity-protecting ID performed by the server apparatus 600 of the communication center 403 when a communication request is transmitted when ID switching processing has been performed at the navigation apparatus 500 will be explained. FIG. 8 is a flowchart of processing for issuing an anonymity-protecting ID by the server apparatus.

As depicted in the flowchart of FIG. 8, the server apparatus 600 determines whether a communication request has been received from the navigation apparatus 500 (step S801). Here, the server apparatus 600 waits until a communication request is received from the navigation apparatus 500 (step S801: NO). Upon receipt of a communication request (step S801: YES), the server apparatus 600 determines whether the communication request received is a request for an anonymity-protecting ID (step S802). At step S802, if the communication request received is not a request for an anonymity-protecting ID (step S802: NO), a series of the processing ends.

At step S802, determination of whether the communication request received is a request for an anonymity-protecting ID may be determined by determining whether the communication request coincides with a predetermined format, or whether a predetermined flag indicative of a communication request is included, or may be arbitrarily set.

At step S802, if the communication request is a request for an anonymity-protecting ID (step S802: YES), the server apparatus 600 acquires the time character string from the ID of the communication request (step S803). The server apparatus 600 then determines whether the time character string acquired at step S803 coincides with a time character string acquired from another communicating terminal (navigation apparatus 500) (step S804).

At step S804, if it determined that the time character string does not coincide (step S804: NO), the server apparatus 600 generates a new anonymity-protecting ID to be used by the navigation apparatus 500 that has transmitted the communication request (step S805), and transmits to the navigation apparatus 500 that has transmitted the communication request, the anonymity-protecting ID generated (step S806), ending a series of the processing. As explained with reference to FIG. 7, if the server apparatus 600 receives a proposed anonymity-protecting ID (e.g., the ID for requesting an anonymity-protecting ID) from the navigation apparatus 500, at step S805, a reply is generated authorizing use of the proposed anonymity-protecting ID as the anonymity-protecting ID.

On the other hand, at step S804, if the time character string is determined to coincide (step S804: YES), the navigation apparatuses 500 cannot be distinguished from each other and hence, the server apparatus 600 transmits a request for retransmission of the communication request to the navigation apparatus 500 that has transmitted the communication request (step S807). Subsequently, flow returns to the processing at step S801 and the server apparatus 600 remains in standby until a communication request is received in response to the request for retransmission transmitted at step S807.

As explained, according to the present example, the navigation apparatus 500 uses an anonymity-protecting ID issued from the server apparatus 600 of the communication center 403 to perform, with the navigation apparatuses 500 equipped on other vehicles 401 and the service providers 404, bidirectional communication that protects anonymity. Upon receipt of an anonymity-protecting ID issued by the server apparatus 600 of the communication center 403, the navigation apparatus 500 performs communication using identification information that protects anonymity, such as time information and random character strings. Therefore, the navigation apparatus 500 can perform communication that maintains anonymity.

The communication method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be distributed through a network such as the Internet.

1-13. (canceled)

14. A communication terminal apparatus performing bidirectional communication with a designated communication destination using identification information acquired from a communication administrating apparatus, the communication terminal apparatus comprising:
a requesting unit that inserts into request information requesting issue of identification information, time information related to transmission of the request information and transmits the request information to the communication administrating apparatus; and a setting unit that sets, as temporary identification information for communication performed with another communication terminal apparatus, identification information issued from the communication administrating apparatus in response to the request information.

15. The communication terminal apparatus according to claim 14, wherein the requesting unit inserts into the request information, in place of the time information, a randomly generated character string and transmits the request information.

16. The communication terminal apparatus according to claim 14, wherein the requesting unit transmits the request information when a predetermined event occurs.

17. The communication terminal apparatus according to claim 14, wherein the requesting unit transmits to the communication administrating apparatus, the request information and a request for authorization of all or a part of the request information to be the identification information, the setting unit, upon receipt of a reply from the communication administrating apparatus in response to the request information and authorizing all or a part of the request information as the identification information, sets the identification information as the temporary identification information for communication performed with another communication terminal apparatus.

18. A communication administrating apparatus administrating issue of identification information used in communication between communication terminal apparatuses, the communication administrating apparatus comprising:
a receiving unit that receives from a communication terminal apparatus, request information requesting identification information and inclusive of time information;
a generating unit that, upon receipt of the request information by the receiving unit, generates the identification information using the request information that includes the time information;
and an issuing unit that issues to the communication terminal apparatus, the identification information generated by the generating unit.

19. The communication administrating apparatus according to claim 18, wherein the generating unit, when the request information received by the receiving unit includes other information different from the time information, generates the identification information using the other information.

20. The communication administrating apparatus according to claim 18, wherein the generating unit, when the request information and a request for authorization of all or a part of the request information to be the identification information are received by the receiving unit, generates and transmits to the communication terminal apparatus, a reply authorizing all or the part of the request information to be the identification information if all or the part of the request information is not being administered as identification information.

21. The communication administrating apparatus according to claim 18, wherein the generating unit, when the request information received by the receiving unit includes other information different from the time information and a request for authorization of all or a part of the request information to be the identification information is received by the receiving unit, generates and transmits to the communication terminal apparatus, a reply authorizing all or the part of the request information to be the identification information if all or the part of the request information is not being administered as identification information.

22. The communication administrating apparatus according to claim 19, wherein the receiving unit transmits to the communication terminal apparatus, an instruction to retransmit the request information, when the identification information generated using the time information or the other information included in the request information is already being administered.

23. A communication method of performing bidirectional-communication with a designated communication destination using identification information acquired from a communication administrating apparatus, the communication terminal method comprising:
a requesting step of inserting into request information requesting issue of identification information, time information related to transmission of the request information and transmitting the request information to the communication administrating apparatus; and a setting step of setting, as temporary identification information for communication performed with another communication terminal apparatus, identification information issued from the communication administrating apparatus in response to the request information.

24. A communication method of administrating issue of identification information used in communication between communication terminal apparatuses, the communication administrating method comprising:
a receiving step of receiving from a communication terminal apparatus, request information requesting identification information and inclusive of time information;
a generating step of generating, upon receipt of the request information at the receiving step, the identification information using the request information that includes the time information;
and an issuing step of issuing to the communication terminal apparatus, the identification information generated at the generating step.

25. A computer-readable recording medium storing therein a communication program that causes a computer to execute the communication method according to claim 23.

26. A computer-readable recording medium storing therein a communication program that causes a computer to execute the communication method according to claim 24.
